(19) United States
(12) Patent Application Publication
(10) Pub. No.: US 2007/0100028 A1
(43) Pub. Date: May 3, 2007

(54) Use of crosslinked polymer composition as a water-absorbing component in sealing and absorption materials and as an admixture for concrete

(76) Inventor: Thomas Mang, Penzberg (DE)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 10/551,226

(22) PCT Filed: Mar. 22, 2004
(86) PCT No.: PCT/EP04/03006

§ 371 Date: Sep. 28, 2005

(30) Foreign Application Priority Data
Mar. 31, 2003 (DE) 103 14 599.0

(51) Int. Cl. C04B 24/26

(52) U.S. Cl. 524/5

(57) ABSTRACT

The invention relates to the use of a crosslinked polymer composition which comprises at least one polymer based on nonionic hydrophilic acrylates and/or methacrylates as a water-absorbing component in concrete or sealing and absorption materials.

The present invention relates to polymer compositions which are suitable for absorbing aqueous liquids, for example in sealing and absorption materials.

### PRIOR ART

Water-absorbing or water-swellable polymer compositions have already been known for a long time.

Thus, WO 99/35208 describes a water-swellable sealing composition which comprises, in addition to a matrix of elastomer components, particulate water-absorbing materials embedded therein. The water-absorbing materials are formed by particulate materials which are a combination of polysaccharides and further synthetic polymers which have a high absorbency for water. These high-absorbency materials additionally used are polymers in the form of high-swelling granules or powder. Linear (meth)acrylic acid polymers and copolymers having a weight-average molecular weight of from 5,000 to 70,000 and crosslinked (meth)acrylic acid polymers and copolymers having a weight-average molecular weight of from 1,000,000 to 5,000,000 are mentioned as being particulary suitable. The particles of the combination then have an average particle size of preferably from 400 to 800 μm. The water-swellable sealing compositions described in this citation are suitable in particular for so-called preformed seals, such as are employed for sealing construction work in overground, underground and tunnel construction and in industrial building.

WO 00/78888 discloses one-component sealing compositions which can be applied to building components in a paste-like form and cured there. Such sealing compositions are employed in overground and underground construction and civil engineering and usually comprise a matrix of non-crosslinked silicone oils, polysulfides and/or polyurethane prepolymers. The crosslinking agent serves to form an elastomer from the matrix material by crosslinking reactions. The sealing compositions contain as the water-swellable or water-absorbing component a particulate water-absorbing material, which in turn is formed from a combination of polysaccharides and polymers, as described above.

There is quite generally a great demand for sealing material in the construction industry. The sealing materials are employed largely to seal off joins and cracks against penetrating water in the ground water area or in sewers or tunnels. In the prior art, various materials which consist of liquids, pastes or tapes are proposed for this. Water-swellable sealing materials which absorb the penetrating water and increase their volume are particularly effective in this context. Due to the swelling and pressing pressure arising as a consequence of the absorption of water, a join or crack always remains tightly closed even after movements, such as, for example, subsidence.

A particular problem of such water-swellable sealing materials is that not only is there a considerable decrease in the swelling properties with respect to electrolyte-containing water, but also that in the event of recurring swelling and drying cycles, a considerable decrease in the water-absorbing properties is to be observed overall.

The object of the invention was consequently to provide a polymeric absorption material which on the one hand shows an adequate absorption capacity with respect to electrolyte-containing water, and which also does not deteriorate substantially in its water-absorbing or water-swellable properties in the event of recurring swelling and drying cycles, in particular in the case of electrolyte-containing water.

This object is achieved by an optionally crosslinked polymer composition which comprises at least one polymer based on nonionic hydrophilic acrylates and/or methacrylates. Nonionic hydrophilic acrylates and/or methacrylates preferably correspond to the general formula

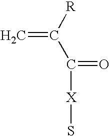

wherein R═H or a methyl group, X=0 or NH and S is a nonionic group and imparts hydrophilic properties. A nonionic group which imparts hydrophilic properties in the context of the present invention is, for example, a polyalkylene glycol chain. Such a chain can be branched or linear and can carry further substitents. The chain preferably corresponds to the formula —(CH₂CH₂O)ₘZ, where m=3 to 1,000 and Z=H or a C₁-C₄-alkyl radical. Those polyalkylene glycol chains in which m=5 to 200 are particularly preferred.

The polymers according to the invention do not have to be built up exclusively from the nonionic hydrophilic acrylates or methacrylates as monomer units, but can additionally contain further monomer building units, which are conventional acrylic acid esters, acrylic acid amides and optionally substituted derivatives of these (meth)acrylic acid derivatives. Acrylic acid derivatives having ionic functional group can also be tolerated in certain amounts.

Those polymers in which the nonionic hydrophilic acrylates and/or (meth)acrylates make up a molar content of at least 30% are preferably provided according to the invention.

The polymers according to the invention can conventionally be in the form of linear or branched polymers or copolymers having a weight-average molecular weight of from 50,000 to 5,000,000.

The side chain S, as a nonionic group which imparts hydrophilic properties, usually includes an oligomer or polymer having a degree of polymerization of between 1 and 10⁶. The hydrophilic properties of the side chain are caused by structural units which are capable of hydrogen bridge bonding. A prerequisite for the formation of hydrogen bridge bonds may be that proton donors, which are derived, for example, from alcohols, thiols, amines or amino acids, are provided in the side chain. On the other hand, the presence of functional groups having an acceptor property may also be necessary, which is often caused by the presence of atoms having free electron pairs. These are conventionally oxygen, nitrogen, halogen or phosphorus. Advantageous groups are alkoxy, amino, amido, azo, cyano, isocyano, nitro, or sulfoxy groups. A side group S in which the oligomer/polymer is a polyethylene glycol is particularly preferred. The degree of polymerization of the side chain is conventionally 1 to 2,000, preferably 3 to 1,000 and very particularly preferably 5 to 200.

Nonionic hydrophilic acrylates or methacrylates which have different degrees of polymerization in the side chain can also be employed according to the invention.

In order to meet the diverse requirements in practice, it is conventionally necessary to crosslink the polymers according to the invention. Possible crosslinking agents are conventionally hydrophilic crosslinking agents, such as, for example, diacrylates, triacrylates, dimethacrylates or trimethacrylates or amide derivatives thereof. The crosslinking agents are employed in an amount of up to 25 wt. %, preferably between 0.01 and 10 wt. %, particularly preferably between 0.05 and 2 wt. %, in each case based on the polymer composition (without additives). Ideally, the polymer composition is crosslinked such that the acrylate units are bonded to one another via an ethylene glycol or polyethylene glycol unit or a polyfunctional alcohol chosen from the group consisting of ethylene glycol dimethacrylate, triethylene glycol dimethacrylate, trimethylolpropane trimethacrylate, 1,3-butylene glycol dimethacrylate or N,N′-methylenebisacrylamide. Particularly advantageous properties result if methoxypolyethylene glycol methacrylate, hydroxypolyethylene glycol methacrylate, methoxypolyethylene glycol acrylate or hydroxypolyethylene glycol acrylate, and mixtures, in particular having a molecular weight of the polyethylene glycol of from 200 to 15,000, preferably 300 to 6,000, are employed as the monomer.

The conventional processes can be employed as the polymerization process. Advantageous processes are inverse suspension polymerization and polymerization in bulk or solution. Depending on requirements and the method chosen, the process can be carried out with or without a solvent. The reaction temperatures are conventionally 0 to 250° C., preferably temperatures of from 15 to 150° C. In some cases it may be advantageous to carry out the reaction in a melt, i.e. with a completely or partly molten reaction mixture. The polymerization product can be in the form of a gel or in the form of a solid. If a gel is present, this can optionally be dried and ground.

According to a particularly preferred embodiment of the present invention, the crosslinked nonionic hydrophilic polymers, as described above, are provided as a particulate water-absorbing or water-swellable material. The average particle size is conventionally 5 to 5,000 μm, preferably 25 to 1,000 μm and particularly preferably 100 to 800 μm (diameter).

The material according to the invention can additionally contain further constituents which may be of importance in the particular desired field of use. These can be, for example, lubricants, anti-ageing agents, dyestuffs, blowing agents, plasticizers, crosslinking agents for rubber, crosslinking accelerators, activators, retardants, crosslinking agents for elastomers etc. Fillers, such as precipitated and/or pyrogenic silica, silicates, sand, mineral flour, such as quartz, talc, mica, chalk, kaolin, ground gypsum, lime, dolomite, basalt, kieselguhr, barite, feldspar, carbon blacks, polymeric hollow bead pigments, wood, wood flour, gum flour dust and swellable inorganic clays, such as bentonites and derivatized bentonites, can moreover be present. Polysaccharides, in particular starch, starch derivatives, cellulose, amylose, amylopectin, dextrans, pectins, inulin chitin, xanthan, alginic acid, alginates, carrageenan and similar compounds can moreover be employed. Plasticizers which can be used are mineral oil of a paraffinic, naphthenic or aromatic nature, ester plasticizers, such as dioctyl phthalate, ester plasticizers based on adipates or sebacates, phosphoric acid esters, stearic acid, palmitic acid, castor oil, cotton-seed oil, rape-seed oil and also polymeric plasticizers, such as, for example, low molecular weight rubbers.

The invention also relates to the use of the optionally crosslinked polymer composition as an additive for concrete. The crosslinked polymer composition can be admixed during the preparation and processing of concrete. In particular, the flow, setting and hardening properties of the concrete mixture can thereby be adapted better to the requirements in practice. The crosslinked polymer composition can moreover also be used for stabilizing purposes or as a swelling blasting agent in concrete formulations. It has been found that the polymers can also be in non-crosslinked form for the intended use discussed here.

As a further embodiment of the present invention, a water-swellable sealing composition is provided which, in addition to a matrix, comprises a particulate material, as described above, distributed therein. Such a sealing material can be, for example, in the form of a preformed seal, i.e. as a continuous profile, tape or circular cord. In such a case, the matrix is preferably a rubber or an elastomer.

As rubber there may be mentioned nitrile rubber, hydrogenated nitrile rubber, ethylene/propylene rubber, ethylene/propylene/diene rubber, copolymers of vinyl acetate and ethylene, as well as terpolymers of ethylene, propylene, and non-conjugated dienes, natural rubber mixtures, polybutadiene, polyisobutylene, butyl rubber, halogenated butyl rubber, copolymers of butadiene with one or more polymerizable, ethylenically unsaturated monomers, such as e.g. styrene, acetonitrile, methyl methacrylate, polyacrylates, polyethers and polymers of substituted butadienes, such as e.g. chlorobutadiene and isoprene, as well as mixtures of various plastics. The matrix-forming rubbers can additionally be crosslinked or vulcanized to elastomers. The matrix preferably comprises vulcanized natural rubber, vulcanized cis-1,4-polyisoprene rubber, vulcanized polybutadiene, vulcanized randomly copolymerized styrene/diene rubbers, vulcanized acrylate rubber, vulcanized acrylonitrile/diene rubbers, vulcanized ethylene/propylene rubber, vulcanized isobutylene/isoprene rubber, vulcanized ethylene/propylene/diene rubber, vulcanized epichlorohydrin rubber, vulcanized silicone rubber, vulcanized polysulfide rubber, crosslinked polyurethane elastomers and crosslinked thermoplastic elastomers.

Suitable crosslinking agents or vulcanizing agents for rubber and crosslinking agents for elastomers are those which are conventional for this purpose, i.e. e.g. sulfur, sulfur compounds, peroxides or the like.

It is particularly advantageous to foam the water-swellable sealing compositions according to the invention. This is usually carried out by measures which are known per se, for example with the aid of blowing agents, such as water, ammonium bicarbonate, sodium bicarbonate or organic blowing agents, such as, for example, sulfohydrazides or azodicarboxamides. Both open-pore foams and closed-pore foams can be prepared. An open-pore foam structure having a density of from 0.4 to 2 g/cm³ is particularly preferred, very particularly preferably of about 0.7 g/cm³.

In the case of paste-like or liquid sealing compositions which only cure in air by means of moisture, the matrix is usually formed by non-crosslinked silicone oils, polysulfides and/or polyurethane prepolymers. Such materials usually cure under the influence of moisture to give polymers having elastomeric properties. Furthermore, in the case of paste-like or liquid sealing compositions, a matrix which comprises two components and cures after mixing of the components can be used.

Compared with known polymer compositions or water-swellable sealing compositions, the compositions according to the invention have the advantage that the swelling capacity can be comparable with respect to electrolyte-containing water, e.g. sea water or cement water, on the one hand, and in water having a very low electrolyte content, such as e.g. rain water, on the other hand. In waters having a high salt content, and especially those containing polyvalent ions, the swelling is often better than with conventional superabsorbers or water-swellable sealing compositions according to the prior art. In practice, this means that the compositions according to the invention meet several profiles of requirements simultaneously. Furthermore, the swelling capacity of the compositions according to the invention is also virtually retained when several wet-dry cycles are passed through.

Known superabsorbers can often also be added to the compositions according to the invention.

It has been possible to demonstrate with the aid of studies that sealing compositions according to the invention (so-called swelling rubbers here) show not only an improved absorption or swelling with respect to electrolyte containing water, but also a stability of the swelling properties with respect to repeated wet-dry cycles with electrolyte-containing water.

The improved absorption or swelling with respect to electrolyte-containing water already manifests itself at a very low electrolyte content, i.e. for example at a salt content of less than 0.5 wt. %, in particular during repeated wet-dry cycles. In fact, sealing compositions according to the prior art already show a significantly deteriorated swellability after a few cycles, especially if the electrolyte-containing water contain di- or trivalent ions. In the case of products according to the invention, an improvement in respect of the swellabilities during repeated wet-dry cycles usually manifests itself. However, the particular properties of the products according to the invention are also already found during a single swelling with electrolyte-containing water which has a particularly high salt content, in particular in sea water having an electrolyte content of more than 1 wt. % up to 2 to 4 wt. % (predominantly monovalent ions, in addition to a relatively small content of divalent ions). Compared with many products of the prior art, the compositions according to the invention show an improved absorption of water when a sealing composition is brought into contact with sea water.

These advantages manifest themselves to a very particular extent in foamed swelling rubbers.

Depending on the amount of fillers employed, the density of the foamed swelling rubbers is in the range between 0.01 g/cm³ and 2.0 g/cm³. Fillers which can be used are, above all: precipitated and/or pyrogenic silica, silicates, sand, mineral flour, such as quartz, talc, mica, chalk, kaolin, ground gypsum, lime, dolomite; basalt, kieselguhr, barite, feldspar, carbon blacks, polymeric hollow bead pigments, wood, wood flour, gum flour dust and swellable inorganic clays, such as bentonites and derivatized bentonites. Polysaccharides, in particular starch, starch derivatives, cellulose, amylose, amylopectin, dextrans, pectins, inulin, chitin, xanthan, alginic acid, alginates, carrageenan and similar compounds can moreover be employed.

Coatings can be applied to the formed sealing compositions according to the invention to delay the swelling or for other purposes, such as e.g. improved mechanical properties, improved resistance to chemicals, such as e.g. organic solvents, acids and alkalis. These coatings are as a rule between 5 and 500 μm, preferably between 20 and 300 μm. Such a coating film can be obtained in various ways. For example, by coating in a dipping bath or spraying. Multi-component systems which can be composed of two or more rubbers having different properties (including combinations of rubbers with at least one swelling rubber or combinations of different swelling rubbers) are particularly advantageous in practice. With such multi-component systems it is possible, for example, to prepare extremely high-performance seals. Compared with known swelling rubber compositions, the swelling rubbers according to the invention have the advantage that the swelling capacity can be comparable with respect to electrolyte-containing water, e.g. sea water or cement water, on the one hand, and in water having a very low electrolyte content, such as e.g. rain water. These properties make it possible to incorporate a relatively large amount of superabsorber into the elastomer matrix, since in the case of conventional superabsorbers a disintegration of the swelling rubber may occur at a very high content thereof as a consequence of too high a swelling pressure.

### EMBODIMENT EXAMPLES

### Example 1

Preparation of a Superabsorber with Inverse Suspension Polymerization

9.5 g methoxy-polyethylene glycol 5000 methacrylate (MPEG-5000-MA; Röhm AG) as well as 0.5 g hydroxyethyl methacrylate (HE-MA) and 0.5 g ethylene glycol dimethacrylate (EGDMA) are initially introduced into a 250 ml glass beaker and 100 g hydraulic oil are then added. The mixture is heated at 130° C., while stirring with a dissolver disc (350-500 rpm), until the MPEG-5000-MA has melted after 5-10 min. 0.4 g azobisisobutyronitrile (AIBN) is then added and the mixture is allowed to react at 130° C. for 2 h. After subsequent cooling, the precipitate formed is separated off over a frit, washed several times with petroleum ether and dried at 50° C. for 1 day. A fine-grained product remains.

### Example 2

Preparation of a Superabsorber in Bulk

100 g of a 75% strength aqueous solution of methoxy-polyethylene glycol 2000 methycrylate (MPEG-2000-MA, Bisomer S20W, Laporte) and 0.118 g trimethylolpropane trimethacrylate (TMPTMA) as well as 2 g of a 25% strength triethanolamine solution are initially introduced into an empty yogurt beaker. 100 g of a freshly prepared 2,5% strength sodium peroxodisulfate (NPS) solution are then added and the substances are mixed thoroughly. After 60 min a gel has formed, which is removed from the beaker and, after trituration, is dried at 50° C. for 2 days. The product dried in this way is ground to a particle size of less than 0.8 mm; larger particles are sieved off.

### Example 3

Preparation of a Swelling Rubber

a) Preparation of the Mixture

The rubber mixture for the sealing material was prepared on a laboratory roll mill, manufacturer: Schwabenthan, Berlin, the ratio of the speeds of rotation of the rear to the front roll (friction) being approx. 1.2. The front roll rotated at approx. 12 rpm; roll temperature: 60° C., mastication time: 5-30 min.

100 parts of natural rubber (SMR, Uniroyal Aachen) was introduced on to the roll at a roll width of approx. 3 mm. The roll nip was narrowed until a cohesive hide runs around the front roll. For accelerated mastication, the rubber was cut in repeatedly with a blade. The mastication broke down the rubber and thus produced the necessary consistency.

After the mastication, 1.5 parts of zinc oxide (active), 2.5 parts of sulfur (90% crystalline), 0.1 part of dibenzothiozyl disulfide (Vulkazit DM, Bayer AG, Leverkusen), 1.2 parts of zinc diethyldithiocarbamate (Vulkazit LDA, Bayer AG, Leverkusen), 0.4 part of tetramethylthiuram disulfide (Vulkazit Thiuram, Bayer AG, Leverkusen), 1 part of stearic acid and 7.5 parts of Porofor TSH paste (foam-forming agent, Bayer AG, Leverkusen) as well as 2 parts of chromium oxide green GX standard were mixed in.

25 parts of potato starch (Müllers Mühle) and 25 parts of superabsorber from Example 2, which were mixed beforehand, are then mixed into 50 parts of this rubber mixture in portions, with waiting after each addition until the particular amount of potato starch/superabsorber had been taken up by the rubber. The hide is taken of at a roll nip of 3 mm.

b) Foaming, Forming, Crosslinking

The hides obtained in this way are cut into strips approx. 1-1.5 cm wide. Three of these are pressed on one another and laid in a track approx. 50 cm having a cross-section of 2 cm×2 cm. The mould is closed and placed in an oven at 100° C. for 30 min. Thereafter, the oven is heated up to 160° C. (duration approx. 30 min). The mould is then removed from the oven, cooled briefly and the tape is removed from the mould. The sealing tapes obtained in this way have a bulk density of 0.81 g/cm³. After 6 days, they show a swelling of 130 vol. % in 4% strength aqueous sodium chloride solution and of 167 vol. % in saturated aqueous Ca(OH)₂ solution (10 g/l), and after 14 days a swelling of 157 vol. % in 4% strength aqueous sodium chloride solution and of 200 vol. % in saturated aqueous Ca(OH)₂ solution (10 g/l).

### Example 4

The hides obtained according to Example 3a) are introduced into an extruder from Brabender, Duisburg, all the heating zones and the die being set at 80° C. The die had a diameter of 3 mm and the barrel a diameter of 2.1 cm. The screw was rotated at 50 rpm. The sausage-shaped extrudate was foamed in an oven at 100° C. for 30 min and then vulcanized at 160° C.

### Example 5

Sealing tapes were produced analogously to Example 3, but in this case with 11 parts of potato starch and 50 parts of superabsorber from Example 2. The sealing tapes obtained in this way had a bulk density of 0.75 g/cm³. After 4 days, they show a swelling of 186 vol. % in 4% strength aqueous sodium chloride solution and of 230 vol. % in saturated aqueous Ca(OH)₂ solution (10 g/l). After 14 days, they show a swelling of 229 vol. % in 4% strength aqueous sodium chloride solution and of 300 vol. % in saturated aqueous Ca(OH)₂ solution (10 g/l). It is found that by increasing the content of the superabsorber prepared according to Example 2 while simultaneously reducing the starch content, the swelling can be greatly increased. The elongation at break of the sealing material is 531%.

### Example 6

25 g hydroxyethyl methacrylate, 200 g MPEG-2000-MA, 2.5 g ethylene glycol dimethacrylate, 30 g of an aqueous 25% strength triethanolamine T85 (BASF) solution, 25 g of a 40% strength aqueous magnesium acrylate solution as well as 191.5 g starch are initially introduced into a glass beaker. A freshly prepared solution of 5 g sodium peroxodisulfate in deionized water is added and the substances are mixed thoroughly. After a reaction time of 1 h, the mass is removed and dried at 50° C. in a circulating air drying cabinet. The very hard material is then comminuted to particle sizes of below 1 mm in a ball mill.

### Example 7

a) Preparation of the Mixture

50 g of the previously comminuted EPDM rubber (type EPT 6250, Bayer AG) was introduced on to the rolls on a laboratory roll mill, manufacturer: Schwabenthan, Berlin, at a roll temperature of 70° C. for the front roll and 60° C. for the rear roll, the roll nip was gradually reduced to 3 mm and the rubber was taken off as a hide. 50 g natural rubber were then introduced on to the rolls and heated slowly, and the roll nip was reduced until a hide can be taken off. As soon as a homogeneous hide had formed, 4 g dioctyl phthalate were added dropwise and the EPDM rubber was then added in portions. During this operation, the hide is cut in again and again and fed through the rolls in folded form.

1.893 g dicumyl peroxide (Merck AG), 5 g Porofor TSH (p-toluenesulfonic acid hydrazide, Rhein Chemie Rheinbau GmbH) and 125 g of the superabsorber from Example 6 were then admixed.

b) Foaming, Forming, Crosslinking

Approx. 75 g of the hide are cut out in an area of 14 cm×14 cm and laid in a mould with the same dimensions of 14 cm×14 cm×0.5 cm. The mould is closed and laid between the plates of a press. The rubber mixture is then foamed at 100° C. for half an hour (under a closing pressure for the mould of 100 bar) and subsequently vulcanized at 160° C. for 2 hours. After removal and cooling of the mould, the foamed rubber is taken out of the mould. The swelling rubber obtained in this way has a bulk density of 0.5-0.9 g/cm³ and, in respect of the mass, a swelling in 4% strength aqueous sodium chloride solution of 132% after 14 days. It is found that if a starch-containing superabsorber is mixed in, a high swelling rate is achieved even without mixing a polysaccharide into the rubber mixture.

### Example 8

a) Preparation of the Mixture

50 g of the previously comminuted EPDM rubber (type EPT 6250, Bayer AG) was introduced on to the rolls on a laboratory roll mill, manufacturer: Schwabenthan, Berlin, at a roll temperature of 70° C. for the front roll and 60° C. for the rear roll, the roll nip was gradually reduced to 3 mm and the rubber was taken off as a hide. 50 g natural rubber were then introduced on to the rolls and heated slowly, and the roll nip was reduced until a hide can be taken off. As soon as a homogeneous hide had formed, 4 g dioctyl phthalate were added dropwise and the EPDM rubber was then added in portions. During this operation, the hide is cut in again and again and fed through the rolls in folded form.

1.4 g dicumyl peroxide (Merck AG), 5 g Porofor TSH (p-toluenesulfonic acid hydrazide, Rhein Chemie Rheinbau GmbH) and 125 g of the superabsorber from Example 6 were then admixed.

b) Foaming, Forming, Crosslinking

Approx. 75 g of the hide are cut out in an area of 14 cm×14 cm and laid in a mould with the same dimensions of 14 cm×14 cm×0.5 cm. The mould is closed and laid between the plates of a press. The rubber mixture is then foamed at 100° C. for half an hour under a closing pressure for the mould of 100 bar and subsequently vulcanized at 160° C. for 2 hours. After removal and cooling of the mould, the foamed rubber is taken out of the mould. The swelling rubber obtained in this way has a bulk density of 0.5-0.9 g/cm³ and, in respect of the mass, a swelling in 4% strength aqueous sodium chloride solution of 176% after 4 days. It is found that a reduced vulcanization leads to a higher degree of swelling in the swelling rubber.

### Example 9

Sealing tapes were produced analogously to Example 3, but in this case with 63 parts of superabsorber from example 2 and without starch. The sealing tapes obtained in this way have a bulk density of 0.84 g/cm³. After 5 days, they show a swelling of 400 vol. % in deionized water, of 300 vol. % in sea water according to ASTM D 1141-98 and of 375 vol. % in saturated aqueous Ca(OH)₂ solution (10 g/l). It is found that the sealing tapes obtained in this way show similar swelling rates in media with a very different electrolyte content. Furthermore, by omission of the starch and the marked increase in the superabsorber from Example 2 which is thus possible, extremely high swelling rates are achieved in electrolyte-containing waters in a short time.

1. Water-swellable sealing composition comprising a matrix formed by rubbers and a particulate material having a particle diameter of from 5 to 5,000 μm distributed therein,
wherein the material comprises a crosslinked polymer composition which comprises at least one polymer in which the content of monomer units derived from nonionic hydrophilic acrylates or methacrylates makes up at least 30 mol %, wherein the nonionic hydrophilic acrylates or methacrylates correspond to the general formula 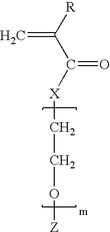
wherein R═H or a methyl group, X═O or NH, m=3 to 1,000 and Z=H or a C₁-C₄-alkyl radical.

2. Sealing composition according to claim 1, wherein the rubber is vulcanized or crosslinked to form an elastomer or vulcanized rubber.

3. Sealing composition according to claim 1, wherein m=5 to 200.

4. Sealing composition according to claim 1, wherein an open-pore foam structure having a density of from 0.4 to 2 g/cm³ is present.

5. Sealing composition according to claim 1, wherein the material has an average particle size of from 100 to 800 μm.

6. Use of a water-swellable sealing composition according to claim 1 as a sealing and absorption material with respect to electrolyte-containing water during repeated wet-dry cycles.

7-8. (canceled)
